(19) United States
(12) Patent Application Publication
(10) Pub. No.: US 2010/0211695 A1
(43) Pub. Date: Aug. 19, 2010

(54) CONTEXT-AWARE COMMUNICATIONS

(75) Inventors: Daphna Steinmetz, Ramat Gan (IL); Michael Cogan, Tel Aviv (IL)

Correspondence Address: Charles N.J. Ruggiero, 10th Floor, One Landmark Square, Stamford, CT, 06901, US

(73) Assignee: COMVERSE, LTD., Tel Aviv (IL)

(21) Appl. No.: 12/706,495

(22) Filed: Feb. 16, 2010

Related U.S. Application Data
(60) Provisional application No. 61/152,839, filed on Feb. 16, 2009.
(60) Provisional application No. 61/259,724, filed on Nov. 10, 2009.

(51) Int. Cl. G06F 15/173

(52) U.S. Cl. 709/242

(57) ABSTRACT

There is provided a system having a processor, and a memory having instructions stored therein in a form that is readable by the processor. The instructions, when read by the processor, cause the processor to perform steps of: receiving a first signal that indicates an initiation of a communication from a calling device to a called device; receiving a context parameter of the called device; evaluating the context parameter; and generating a second signal, based on the step of evaluating, to control a routing of the communication.

### CROSS-REFERENCE TO RELATED APPLICATIONS

This application claims priority in U.S. Provisional Patent Application Ser. No. 61/152,839, filed on 16 Feb. 2009, the content of which is incorporated herein by reference. This application also claims priority in U.S. Provisional Patent Application Ser. No. 61/259,724, filed on 10 Nov. 2009, the content of which is also incorporated herein by reference.

### BACKGROUND OF THE INVENTION

1. Field of the Invention

The present disclosure relates to communications between users. More particularly, the present disclosure relates to context-aware communications between users.

2. Description of the Background Art

The background art deals with numerous communications schemata for users. However, lacking in the background art are methods and systems for providing communications that are adjusted according to a context in which one or more intended receiving devices or parties to the communications may find himself or herself.

A communication has a particular form, is carried in a given format, and is communicated over a channel. The background art leaves an unfilled need for a system and method of context-aware communications that is sensitive to a user's doings and surroundings. According to the limitations of the background art, there is lacking a system that takes into account factors extrinsic to a message to be transmitted (that is, context), and, having done so, completes communication of the message according to the context.

### SUMMARY OF THE INVENTION

The present disclosure provides a system that is sensitive to the doings and surroundings of the receiving device or party, both in real time and in view of repeated past behavior (habits).

The present disclosure also provides a system that modifies the communication channel to fit the individual need of the receiving device or party.

The present disclosure further provides a system having a processor, and a memory having instructions stored therein in a form that is readable by the processor. The instructions, when read by the processor, cause the processor to perform steps of: receiving a first signal that indicates an initiation of a communication from a calling device to a called device; receiving a context parameter of the called device; evaluating the context parameter; and generating a second signal, based on the step of evaluating, to control a routing of the communication.

The present disclosure further provides a method comprising steps of: receiving a signal that indicates an initiation of a communication to a called device; receiving a context parameter of the called device; evaluating the context parameter; and generating a signal, based on the step of evaluating, to control a routing of the communication (including the media and format), in which the step of evaluating is executed by a processor.

The present disclosure further provides a system comprising: a processor; and a memory having instructions stored therein in a form that is readable by the processor. The instructions, when read by the processor, cause the processor to perform steps. The steps include: receiving from a device a sub-context; evaluating the sub-context to generate a context parameter; and storing the context parameter in a repository. Alternatively, the steps include generating a parameter that is a sub-context or a context; and generating a signal that carries the parameter.

### BRIEF DESCRIPTION OF THE DRAWINGS

FIG. 1 is a context-aware communications system.

FIG. 2 is a flow diagram showing communications with a context server.

FIG. 3 is a flow diagram showing context sensitive call setup.

FIG. 4 is a block diagram of a mobile device.

FIG. 5 is a block diagram of a context server.

FIG. 6 is a block diagram of a context sensor.

FIG. 7 is a block diagram of a method for routing a communication.

### DESCRIPTION OF THE INVENTION

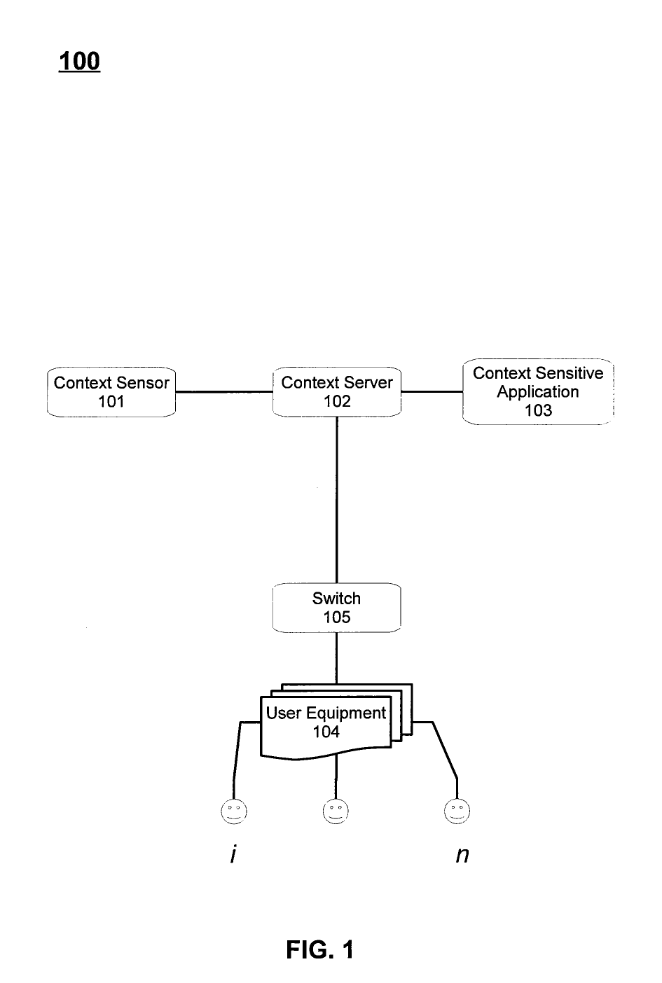

Referring to the drawings and, in particular, FIG. 1, there is shown a context-aware communication system generally referred to by reference numeral 100. System 100 has a context sensor 101, context server 102, context sensitive application 103, user equipment 104, and a switch 105. Each of context sensor 101, context sensitive application 103, user equipment 104, and switch 105 are in communication with context server 102 via communication links that are, collectively, a communication network. Such communication links can be any suitable circuit-switched or packet-switched link, such as, for example, TCP/IP. In an embodiment, user equipment 104 is a plurality of user equipment used by users i . . . n.

Context-aware communications are sensitive to the user's doings and surroundings, and modify a communication channel to fit individually each user's particular communications needs. Using context-aware communications, the conversational and situational contexts of the user are insinuated into a communication channel, and are used to modify aspects of the communication channel.

An end-user of a communications system is said to have a context, which is inferred from a context of the communication device of the user. The methods and systems of the present disclosure advantageously sense the user's context in any combination of real time, or offline. The context as a whole comprises n sub-contexts. Thus the context can be thought of as an n-dimensional matrix. In an embodiment, the sub-contexts include situational context, social context, conversational context, and behavioral context. The sub-contexts are considered, given a weight according to their importance, and evaluated to result in the context.

By way of nonlimiting example, the situational context of the user is derived from one or more of the location of the user's communication device, or a roaming status thereof. Also part of situational context is whether the user is indoors or outdoors; is in transit; is stationary; is in a meeting or some gathering.

The social context is a metric of the company the user keeps, be it retrospectively (“who was with the user?”), instantaneously (“who is with the user”), predictively (“who will be with the user?), or on average (“who is usually with the user?”). or, who are friends of the user according to an Address book of the user or social contacts of the user in web communities.

The user may be, for example, on a voice call or a video call. He may be in a chat session. His communication device may be downloading media.

Behavioral context may comprise any combination of the user's communications history; his numbers dialed; his calls made/received; his past consumed content.

Any of these aspects of a user's context can be collected real-time (e.g., whether the user is on a call) or offline (e.g., the user's call history). The user's context can be updated manually by the user (e.g., he steps into a meeting and places his communication device on a ‘meeting’ setting) or can be sensed automatically by a context-aware communication system (e.g. the user's communication device is sensed to be in motion).

The present disclosure makes use of context information to personalize the user's communication experience, to adapt communication services for the user in particular situations, and to allow the user to share communication experiences better.

### Example 1

### Conversational Context

At 7:00 PM User Alfa uses her communication device to initiate a call to user Beta. However, Beta's communication device (and, by implication Beta himself) is sensed by a context-aware communication system to be in a roaming condition and in a locale where it is 2:00 AM. Alfa, upon attempting to initiate the call, will therefore receive an alert from the context-aware communication system informing her that Beta is in a different time zone. Alfa will then be presented with an option to continue her call to Beta or to leave a voice message for Beta (who is likely to be asleep at 2:00 AM). In an embodiment, raw data underlying the alert are transformed into a format that is presented perceptibly to one or more of Alfa's senses, such as an aural tone, a vibration, or a textual message presented by Alfa's communication device. Alfa uses an input device of her communication device to signal her response to the alert back to the context-aware communication system.

### Example 2

### Situational Context

User Alfa uses her communication device to initiate a call to user Beta. However, Beta has placed his communication device in silent mode. A context-aware communication system infers a situational context of Beta (i.e., that Beta may be in a meeting). Alfa, upon attempting to initiate the call, will therefore receive an alert from the context-aware communication system informing her that Beta may be unable to receive her call. Alfa will be presented with an option to continue her call to Beta or to leave a voice message for Beta.

### Example 3

### Situational Context

User Beta is a receiver of a transmission of high-bandwidth media from a publisher, which media he receives on his communication device. However, his communication device will have poor performance (e.g., latency, jitter) on realtime tasks, e.g., video/audio calls, if his communication device is in the midst of receiving the transmission during the realtime tasks. Accordingly, a context-aware communication system senses when Beta is performing a realtime task, and provides a signal to the publisher that instructs the publisher to reschedule the transmission until after the realtime task, to reformat the transmission to a low-bandwidth format, or to throttle the transmission during the realtime task. Thus, Beta's realtime tasks are completed smoothly and more pleasingly for Beta without extreme impairment of the transmission.

### Example 4

### Situational Context

User Beta uses his communication device to subscribe to an online music service. Iota's communication device has an accelerometer therein. Beta's communication device collects input from the accelerometer, which input is used to deduce that Iota frequently goes for runs. A context-aware communication system receives a signal from Beta's communication device that indicates Beta is running. In turn, the context-aware communication system signals the music service, which offers Beta a selection of music that is suited for running. Immediately after Beta's communication device senses Iota's run is complete, Advertiser is signaled by the context-aware communication system, and in response transmits to Beta an advertisement for painkillers.

### Example 5

### Social Context

User Beta receives from time to time on his communication device a selection of advertisements from Advertiser. A context-aware communication system senses that Beta's communication device (and therefore by implication Beta himself) is within only a couple meters of another's, Eta's, communication device (and therefore by implication Eta himself). The context-aware communication system thus provides a signal to Advertiser that informs the Advertiser of the sensed proximity of Beta and Eta. Advertiser then communicates an advertisement to Beta that is, say, pertinent to Beta and Eta's shared interests.

### Example 6

### Behavioral Context

User Beta, who lives in New York City, receives on his communications device mainly communications that originate in Greece. A context-aware communication system compiles Beta's received-call history, and communicates a summary of the call history to Advertiser with a suggestion that Advertiser communicate an advertisement concerning Greek products to Beta.

Generally, the present disclosure allows modification of a visual channel of communication to a vocal channel, or vice versa. This is advantageous if a user is unable to assimilate a visual message, such as when the user is in the dark or operating a vehicle, but is able to listen to an aural message. In like fashion, if a user is able to view, but not listen to, a communication, such as if the user is in a meeting, then the present disclosure advantageously allows conversion of an aural communication to a visual one.

The present disclosure also permits the modification of an interactive channel, such as voice or video, to an off-line channel, such as SMS or MMS. The reverse is also contemplated. Thus, an interactive real-time communication, like a telephone call, may be directed to a user whose situational context (sitting in a meeting) makes answering a call impractical; this is accomplished by using a non-interactive channel to carry the meaning of the telephone call to the user for his later offline consumption.

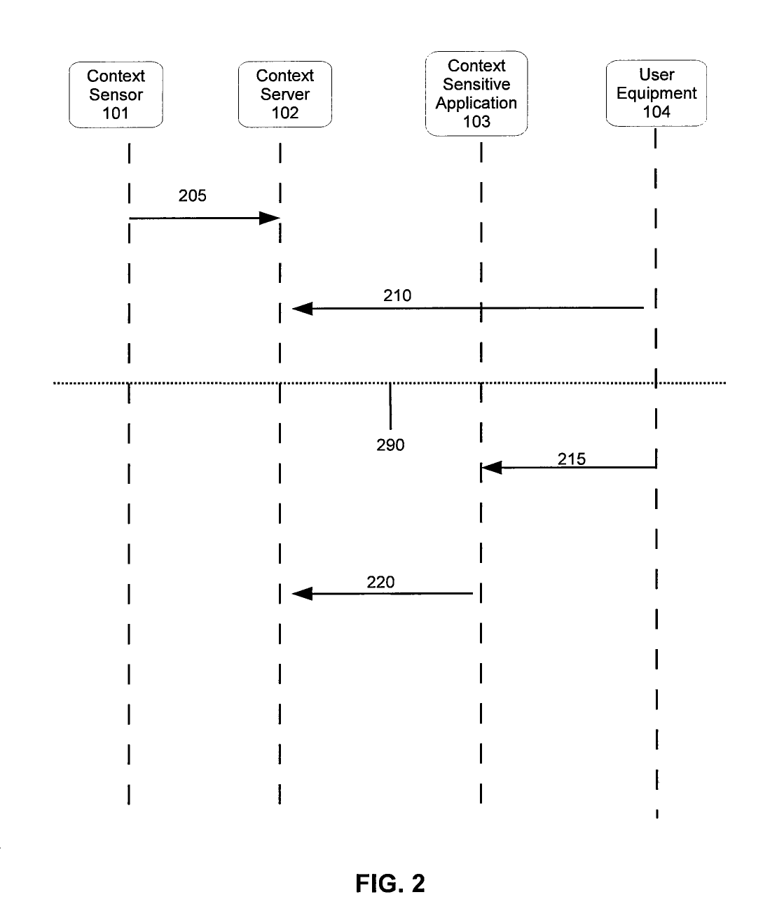

FIG. 2 shows communications with a context server 102. Context sensor 101 senses a context change in context-aware communication system 100. The context change may be, for example, a location or a status of user equipment 104. In communication 205, context sensor 101 signals, i.e., updates, context server 102 with current context.

When a user updates his context (e.g. meeting mode, silent mode, playing a game) on user equipment 104, which is for example a communication device, user equipment 104 sends communication 210 to context server 102, which communication comprises the user's context. Phase delimiter 290 delimits, generally, communications that sense or set up context (e.g., communications 205 and 210), and those communications that act on context (e.g., communications 215 and 220).

User equipment 104 accesses a context sensitive service or launches a context sensitive application 103 with a communication 215. In turn, context sensitive application 103 establishes a communication 220 with context server 102 to retrieve a current context state for the user.

Context sensitive application 103 uses the user's current context state, retrieved from context server 102, for adapting the context sensitive service. In an exemplary embodiment, context sensitive application 103 changes text to voice, or voice to text, or sends a predefined text message to a calling user when a called user is unable to answer a call (e.g., when the called user's phone is in the “in meeting” state). In another exemplary embodiment, context sensitive application 103 plays a prompt to the calling user before the call is fully set up, to inform the calling user that the called user is, for example, in a different time zone, is driving, or is in silent mode.

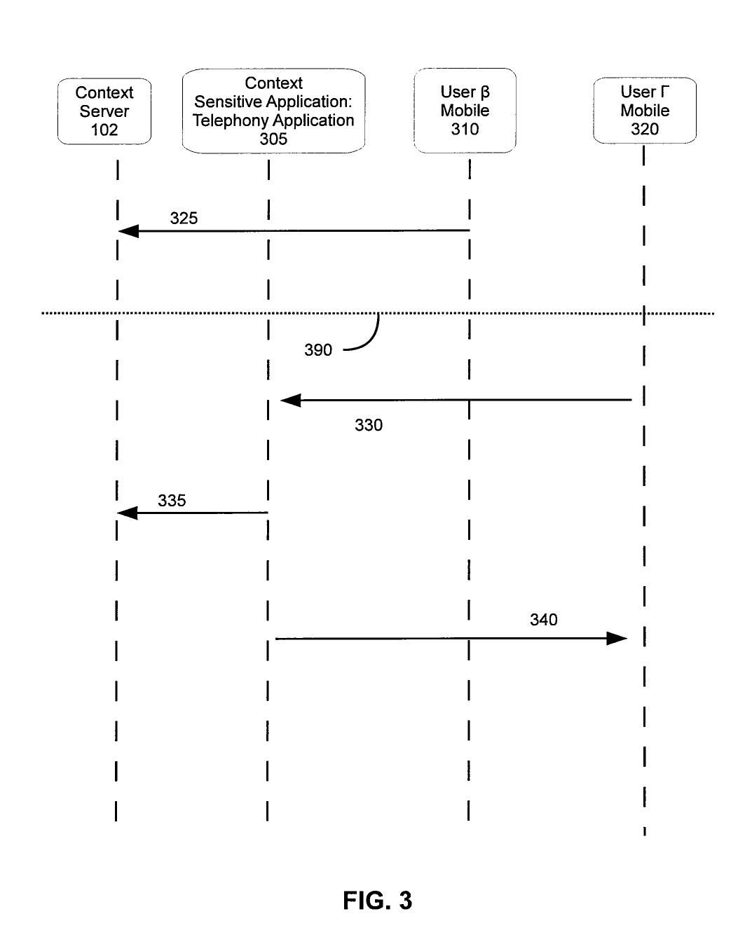

Referring to FIG. 3, a user (Beta)) configures mobile device 310 to silent mode. This configuration is signaled to context server 102 in communication 325. Phase delimiter 390 delimits, generally, communications that sense or set up context at an initiation of a call (e.g., communication 325), and those communications that act on context (e.g., communications 330, 335, and 340).

A second user (Gamma) uses his mobile device 320 to initiate a call to user Beta on mobile device 310 using context sensitive telephony application 305. This initiation of the call is effected by communication 330. Application 305 may be remote to mobile device 320, or resident in a storage device on mobile device 320. In turn, application 305 consults with, and is updated by, context server 102 to obtain context (here, silent mode) for mobile device 310; this is effected in communication 335.

Application 103, being updated with user Beta's silent mode context, prepares a prompt for presentation to user Gamma via a user interface of mobile device 320. Presentation of the prompt on mobile device 320 is effected with communication 340. In the prompt, user Gamma is offered a choice of sending user Beta a non-realtime message (e.g., sms, mms), leaving user Beta a voice mail, or waiting for Beta to answer the call.

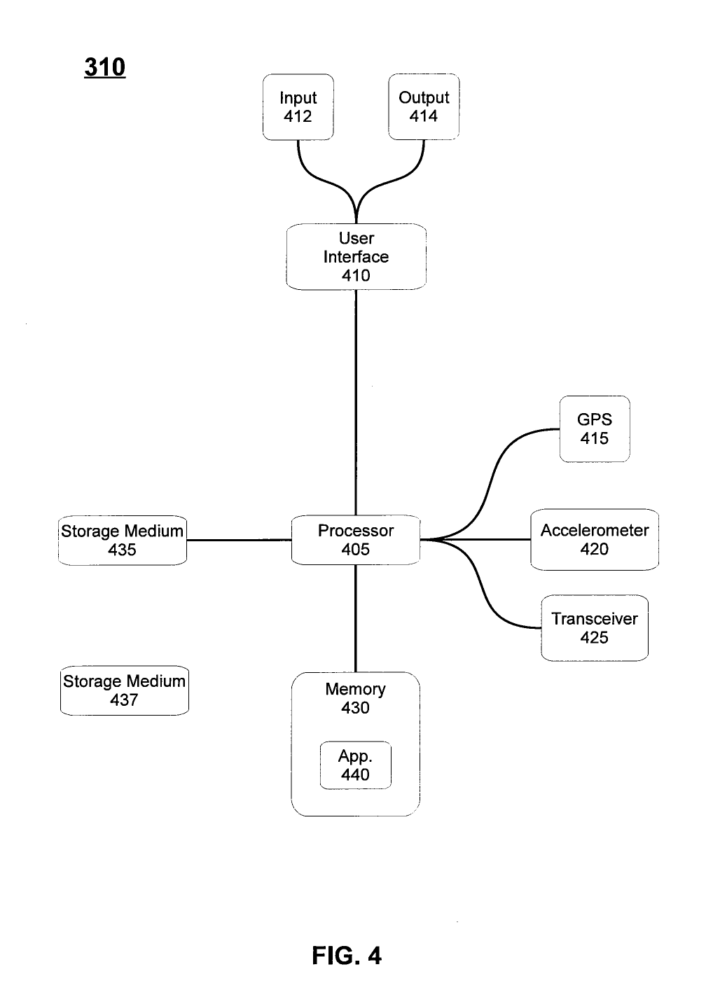

FIG. 4 shows a mobile device 310. Mobile device 310 provides a central processor 405 that is in communication with a plurality of modules. As used herein, the term “module” may denote a functional unit that is implemented in one or more of software, firmware, hardware, and equivalents thereof.

One such module is a user interface 410. User interface 410 provides an input 412 that is a man-machine interface (MMI) with controls for a user to command mobile device 410. User interface 410 further provides an output 414 for communicating prompts, alerts, menus, dialogs, and other necessary signals that are perceptible to the user visually, aurally, tactilely, or some combination thereof.

Processor 405 is also in communication with a GPS receiver 415, an accelerometer 420, and a transceiver 425.

Transceiver 425 is an interface to a communication channel or communication network, such as, for example, a mobile telephony network, a TCP/IP network, or a circuit-switched network. Transceiver 425 places mobile device 310 in communication with one or more of a context server 102, context sensor 101, a switch 105, or any number of other communication devices (not shown).

Mobile device 310 further provides a memory 430 that is in communication with processor 405. An application 440 is resident in memory 430 and ultimately executed by processor 405. Computer-readable instructions of application 440 are persistently stored on a storage medium 437 for loading into memory 430. In an exemplary embodiment, application 440 is a context sensitive application, and/or an application for accessing a context sensitive service. In an exemplary embodiment, application 440 is persistently stored in a machine-readable format by storage medium 437, which in turn may be physically distant from processor 405, local to processor 405, or some combination of local and distant.

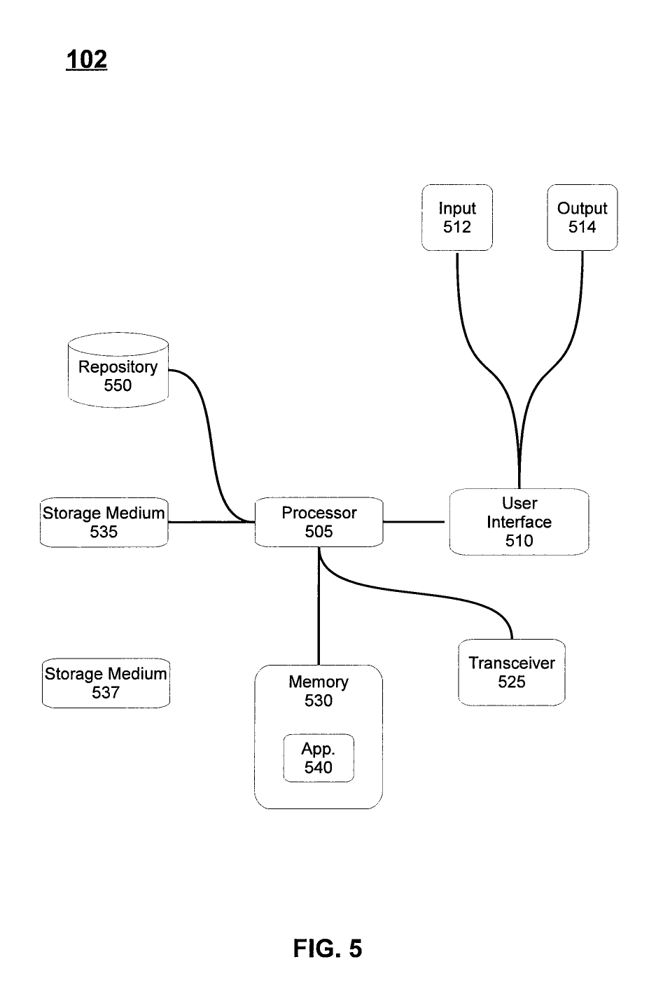

Referring to FIG. 5, context server 102 provides a central processor 505 that is in communication with a plurality of modules.

One such module is a user interface 510. User interface 510 provides an input 512 that is a man-machine interface (MMI) with controls for a user to command context server 102. User interface 510 further provides an output 514 for communicating prompts, alerts, menus, dialogs and other necessary signals that are perceptible to the user visually, aurally, tactilely, or some combination thereof.

Context server 102 further provides a memory 530 that is in communication with processor 505. An application 540 is resident in memory 530 and ultimately executed by processor 505. In an embodiment, application 540 is a context sensitive application, and/or an application for accessing a context sensitive service. Computer-readable instructions of application 540 are persistently stored on a storage medium 537 for loading into memory 530. Memory 530 in turn may be physically distant from processor 505, local to processor 505, or some combination of local and distant.

Processor 505 is also in communication with a transceiver 525. Transceiver 525 is an interface to a communication channel or communication network, such as, for example, a mobile telephony network, a TCP/IP network, or a circuit-switched network. By way of transceiver 525, context server 102 communicates with other entities participating in a context-aware communication system, such as context sensor 101, context sensitive application 103, user equipment 104, mobile device 310, and switch 105.

Processor 505 is in communication with a repository 550 for storing a context parameter, such as a context parameter for a mobile device 310.

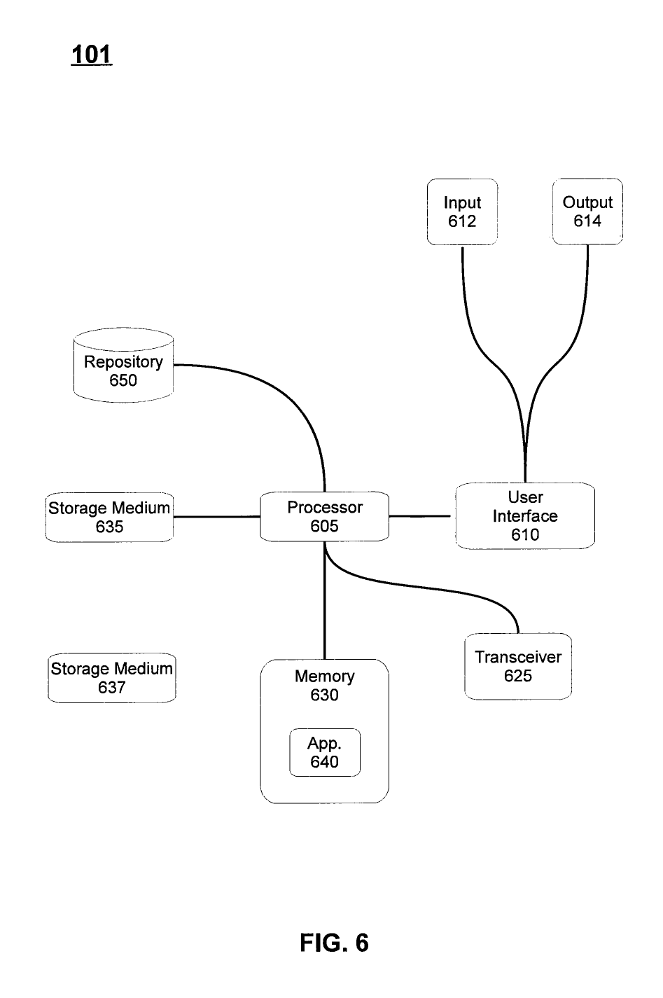

FIG. 6 illustrates context sensor 101. Context sensor 101 provides a central processor 606 that is in communication with two or more modules.

One such module is a user interface 610. User interface 610 provides an input 612 that is a man-machine interface (MMI) with controls for a user to command context sensor 101. User interface 610 further provides an output 614 for communicating prompts, alerts, menus, dialogs, and other necessary signals that are perceptible to the user visually, aurally, tactilely, or some combination thereof.

Context sensor 101 further provides a memory 630 that is in communication with processor 606. An application 640 is resident in memory 630 and ultimately executed by processor 606. In an exemplary embodiment, application 640 is an application for receiving from a device, a context or any sub-context of the context. Application 640 writes received the context and sub-context to repository 650, which is a persistent computer-readable storage medium. Computer-readable instructions of application 640 are persistently stored on a storage medium 637 for loading into memory 630. Memory 630 in turn may be physically distant from processor 605, local to processor 605, or some combination of local and distant.

Processor 606 is also in communication with a transceiver 626. Transceiver 626 is an interface to a communication channel or communication network, such as, for example, a mobile telephony network, a TCP/IP network, or a circuit-switched network. By way of transceiver 626, context sensor 101 communicates with other entities participating in a context-aware communication system, such as a context server 102, a context sensitive application 103, user equipment 104, and mobile device 310.

Processor 605 is in communication with a repository 650 for storing a context parameter, such as a context parameter for a mobile device 310.

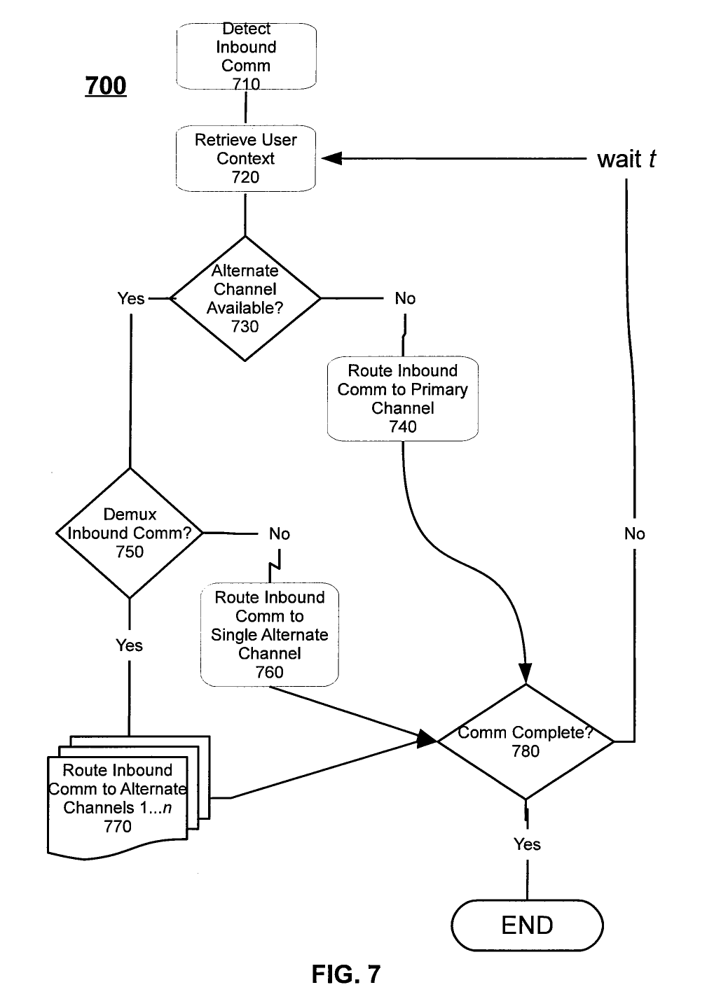

FIG. 7 shows a method 700 for routing a communication in a context-aware communication system. Method 700 commences at step 710, when a communication inbound to a user is detected. Such detection includes a detection of a communication channel of the inbound communication. Method 700 next progresses to step 720.

At step 720, a context for the user is detected. In an exemplary embodiment, the context is detected and retrieved from context server 102. Method 700 next progresses to step 730.

At step 730, the context-aware communication system determines, according to at least the nature of the inbound communication and the context of the user, whether an alternate channel for the communication is available. If no alternate channel is available, then the inbound communication is routed to a primary channel at step 740. Thus, if the inbound communication is a telephone call and the user's context indicates that the user has ready access only to his mobile phone, then the inbound communication will be routed to the user's mobile phone as normal.

By way of example, if the inbound communication is a request to initiate a high-bandwidth video call, and if the context is that the user is at home, then an alternate channel is available (to wit, presenting the inbound communication to the user via the user's television set or home computer instead of the user's mobile phone). Thus, a high-bandwidth communication will be rerouted to a channel other than a primary channel. Method 700 next proceeds to step 750.

At step 750, the nature of the inbound communication and the user's context are used to determine whether the inbound communication should be further subdivided, or demultiplexed, to one or more alternate channels. If not, then method 700 proceeds to step 760 and the inbound communication is presented to the user on a single alternate channel, and method 700 next proceeds to step 780. If yes, then method 700 proceeds to step 770.

At step 770, the inbound communication is further subdivided for presentation on n alternate channels. By way of example, if the communication is an inbound call with a high-bandwidth video component and a speech-quality audio component, then the communication will be subdivided so the video component is routed to a first alternate channel (e.g., the user's television) and the audio component is routed to a second alternate channel (e.g., the user's mobile phone). By way of further example, the communication could be subdivided into several substantially alike alternate channels; each of which alternate channels are routed to communication devices held by other users in addition to the user, thus creating a sort of ad hoc conference based on social or situational context. Method 700 next proceeds to step 780.

At step 780, the context-aware communication system determines whether the communication is complete. If yes, then method 700 ends. If the communication is not complete, then method 700 returns to step 720 to receive an update of the user's context. In an embodiment, method 700 will wait for a time t before retrieving the user's context.

The techniques described herein are exemplary, and should not be construed as implying any particular limitation on the present disclosure. It should be understood that various alternatives, combinations and modifications could be devised by those skilled in the art. The present disclosure is intended to embrace all such alternatives, modifications and variances that fall within the scope of the appended claims.

What is claimed is:

1. A system comprising:
a processor; and
a memory having instructions stored therein in a form that is readable by said processor, wherein said instructions, when read by said processor, cause said processor to perform the steps of:
receiving a first signal that indicates an initiation of a communication from a calling device to a called device;
receiving a context parameter of the called device;
evaluating said context parameter; and
generating a second signal, based on said step of evaluating, to control a routing of the communication.

2. The system of claim 1, wherein said context parameter comprises a plurality of sub-contexts from the group consisting of (i) a situational context; (ii) a social context; (iii) a conversational context; (iv) a behavioral context; and (v) any combinations thereof.

3. The system of claim 2, wherein said step of evaluating comprises:
weighting each of said sub-contexts.

4. The system of claim 1, wherein said instructions cause said processor to perform steps of:
communicating a prompt to the calling device before said generating of said second signal; and
receiving a response to the prompt before said generating of said second signal.

5. The system of claim 4 wherein said second signal is based on said step of evaluating and said response.

6. The system of claim 1, wherein said routing of the communication effects a change of the communication from a first format to a second format.

7. A method comprising steps of:
receiving a signal that indicates an initiation of a communication to a called device;
receiving a context parameter of the called device;
evaluating said context parameter;
generating a signal, based on said step of evaluating, to control a routing of the communication,
wherein said step of evaluating is executed by a processor.

8. The method of claim 7, wherein said context parameter comprises a plurality of sub-contexts from the group consisting of (i) a situational context; (ii) a social context; (iii) a conversational context; (iv) a behavioral context; and (v) any combinations thereof.

9. The method of claim 8, wherein said step of evaluating comprises:
weighting each of said plurality of sub-contexts.

10. The method of claim 7, further comprising steps of:
communicating a prompt to the calling device before said generating of said second signal; and
receiving a response to the prompt before said generating of said second signal.

11. The method of claim 10, wherein said second signal is based on said step of evaluating and said response.

12. The method of claim 7, wherein said routing of the communication effects a change of the communication from a first format to a second format.

13. A system comprising:
a processor; and
a memory having instructions stored therein in a form that is readable by said processor, wherein said instructions, when read by said processor, cause said processor to perform steps of:
receiving from a device a sub-context;
evaluating said sub-context to generate a context parameter; and
storing said context parameter in a repository.

14. The system of claim 13, wherein said sub-context is selected from the group consisting of (i) a situational context; (ii) a social context; (iii) a conversational context; (iv) a behavioral context; and (v) any combinations thereof.

15. A system comprising: a processor; and
a memory having instructions stored therein in a form that is readable by said processor, wherein said instructions, when read by said processor, cause said processor to perform steps of:
generating a parameter that is a sub-context or a context; and
generating a signal that carries said parameter.

16. The system of claim 15, wherein said parameter is based on a physical location of said processor.
